(19) United States
(12) Patent Application Publication
(10) Pub. No.: US 2025/0007139 A1
(43) Pub. Date: Jan. 2, 2025

(54) METHOD FOR PRODUCING BANDPASS FILTER, AND BANDPASS FILTER

(71) Applicant: HAMAMATSU PHOTONICS K.K., Hamamatsu-shi, Shizuoka (JP)

(72) Inventors: Takafumi SEKO, Hamamatsu-shi, Shizuoka (JP); Masaomi TAKASAKA, Hamamatsu-shi, Shizuoka (JP); Hiroshi OKAMOTO, Hamamatsu-shi, Shizuoka (JP)

(73) Assignee: HAMAMATSU PHOTONICS K.K., Hamamatsu-shi, Shizuoka (JP)

(21) Appl. No.: 18/711,929

(22) PCT Filed: Nov. 1, 2022
(86) PCT No.: PCT/JP2022/040900

§ 371 Date: May 21, 2024

(30) Foreign Application Priority Data
Nov. 25, 2021 (JP) 2021-190774

(51) Int. Cl. H01P 1/207; H01P 1/20; H01P 11/00

(52) U.S. Cl. CPC H01P 1/207; H01P 1/2002; H01P 11/00

(57) ABSTRACT

This method for producing a bandpass filter is a method for producing a bandpass filter made of a dielectric multilayer film including: a cavity layer made of TiO₂; and laminated portions arranged to sandwich the cavity layer, the laminated portion being formed by alternately laminating a first dielectric layer made of a high refractive index material and a second dielectric layer made of a low refractive index material, in which in a film formation step of the dielectric multilayer film, a film formation stop period to lower a temperature of a film formation substrate by temporarily stopping film formation during the film formation step is set.

### TECHNICAL FIELD

The present disclosure relates to a method for producing a bandpass filter and a bandpass filter.

### BACKGROUND ART

In an optical-related technology, a bandpass filter that transmits only a wavelength in a desired band is known. The bandpass filter may be configured by a dielectric multilayer film. For example, the bandpass filter described in Patent Literature 1 is configured by alternately stacking high refractive index dielectric layers made of TiO₂ and low refractive index dielectric layers made of SiO₂ on both sides of a cavity layer made of SiO₂. In this conventional bandpass filter, when a center wavelength of a transmission band is λ₀, film thicknesses of the high refractive index dielectric layer and the low refractive index dielectric layer are λ₀/4, and a film thickness d of the cavity layer is shifted from λ₀/2, which is a standard value, to either a larger or smaller value in a range of 0 to λ₀/2.

### CITATION LIST

### Patent Literature

Patent Literature 1: Japanese Unexamined Patent Publication No. H7-104122

### SUMMARY OF INVENTION

### Technical Problem

In general, the bandpass filter has angle dependence with respect to an incident angle θ of light. The angle dependence is caused based on an optical path difference between reflected light on one surface of the cavity layer and reflected light on the other surface of the cavity layer. The optical path difference is derived by Snell's law and a trigonometric function formula. The optical path difference is maximized at θ=0° and gradually decreases as θ increases. In the bandpass filter, the center wavelength of the transmission band shifts to a shorter wavelength side as the optical path difference decreases. Therefore, from the viewpoint of reducing the angle dependence of the bandpass filter, it is advantageous to use a high refractive index material such as TiO₂ for the cavity layer.

The film thickness of the cavity layer is also an important factor in film design of the bandpass filter. For example, as the film thickness of the cavity layer is larger, the transmission band is narrower and has a sharper rise. In addition, when the high refractive index material such as TiO₂ is used for the cavity layer, the angle dependence decreases as the film thickness increases. From the above, it is considered that it is necessary to form a cavity layer having a large film thickness using the high refractive index material such as TiO₂ in order to reduce the angle dependence of the bandpass filter.

On the other hand, when the cavity layer having the large film thickness is formed using the high refractive index material such as TiO₂, there is a problem that crystallization of TiO₂ proceeds and the cavity layer becomes cloudy during film formation. When cloudiness occurs in the cavity layer, the transmission band of the bandpass filter may be greatly deviated from the design. Further, the cloudiness of the cavity layer can also be a factor in scattering of light incident on the bandpass filter. Therefore, even when the cavity layer having the large film thickness is formed using the high refractive index material, there has been a desire for a technique capable of suppressing the cloudiness of the cavity layer.

The present disclosure has been made to solve the above problems, and an object of the present disclosure is to provide a method for producing a bandpass filter and a bandpass filter capable of suppressing the cloudiness of the cavity layer even when the cavity layer having the large film thickness is formed using the high refractive index material.

### Solution to Problem

A method for producing a bandpass filter according to one aspect of the present disclosure is a method for producing a bandpass filter made of a dielectric multilayer film including: a cavity layer made of TiO₂; and laminated portions arranged to sandwich the cavity layer, the laminated portion being formed by alternately laminating a first dielectric layer made of a high refractive index material and a second dielectric layer made of a low refractive index material, in which in a film formation step of the dielectric multilayer film, a film formation stop period to lower a temperature of a film formation substrate by temporarily stopping film formation during the film formation step is set.

In the method for producing the bandpass filter, the temperature of the film formation substrate is lowered by setting the film formation stop period in the film formation step of the dielectric multilayer film. Thus, progress of the crystallization of TiO₂ can be suppressed as compared with a case where all layers are continuously formed. Therefore, even when the cavity layer having the large film thickness is formed using TiO₂ that is the high refractive index material, it is possible to suppress the cloudiness of the cavity layer. By suppressing the cloudiness of the cavity layer, in the produced bandpass filter, a transmittance in the transmission band can be improved and the scattering can be sufficiently reduced, and the angle dependence on incident light can be reduced.

The film formation stop period may be set to a period in which an outermost layer of the dielectric multilayer film is the second dielectric layer. Stability of film formation can be improved by performing the film formation stop period in a state in which the low refractive index dielectric layer made of a material having relatively high stability with respect to an external environment is used as the outermost layer of the dielectric multilayer film.

The film formation stop period may be set a plurality of times in the film formation step. Thus, it is possible to stably suppress an increase in the temperature of the film formation substrate over an entire period of the film formation step. Therefore, the cloudiness of the cavity layer can be more reliably suppressed.

When a center wavelength of a transmission band is λ and a film thickness of the cavity layer formed in the film formation step is D, D=λ/2×m (m is an integer of 3 or more) may be satisfied. According to the present method, even when the cavity layer having the large film thickness is formed such that D=λ/2×m (m is an integer of 3 or more), the cloudiness of the cavity layer can be suitably suppressed.

The λ may be 400 nm or more and 1000 nm or less. According to the present method, even when the cavity layer having the large film thickness is formed such that the λ is 400 nm or more and 1000 nm or less, the cloudiness of the cavity layer can be suitably suppressed.

The film formation step may be performed using a vacuum vapor deposition apparatus. In this case, by stopping the film formation in a state of maintaining a vacuum state in the apparatus in the film formation stop period, the temperature of the film formation substrate can be relatively easily lowered by heat dissipation of the entire apparatus.

A bandpass filter according to one aspect of the present disclosure is made of a dielectric multilayer film including: a cavity layer made of TiO₂; and a laminated portion formed by alternately laminating a first dielectric layer made of a high refractive index material and a second dielectric layer made of a low refractive index material, in which when a center wavelength of a transmission band is λ and a film thickness of the cavity layer is D, D=λ/2×m (m is an integer of 3 or more), and a transmittance in the transmission band is 80% or more. In addition, the scattering in the transmission band may be less than 5%.

### Advantageous Effects of Invention

According to the present disclosure, even when the cavity layer having the large film thickness is formed using the high refractive index material, the cloudiness of the cavity layer can be suppressed.

### BRIEF DESCRIPTION OF DRAWINGS

FIG. 1 is a schematic cross-sectional view illustrating a layer configuration of a bandpass filter according to an embodiment of the present disclosure.

FIG. 2 is a schematic diagram illustrating a transmission band of the bandpass filter illustrated in FIG. 1.

FIG. 3 is a schematic view illustrating an optical path difference between reflected light on one surface of a cavity layer and reflected light on the other surface of the cavity layer.

FIG. 4 is a diagram illustrating a relationship between an incident angle and the optical path difference.

FIG. 5 is a diagram illustrating a relationship between a film thickness of the cavity layer and a spectral shape of the transmission band.

FIG. 6 is a diagram illustrating a relationship between the film thickness of the cavity layer and angle dependence.

FIG. 7 is a diagram illustrating an example of the transmission band of the bandpass filter in a case where the film thickness of the cavity layer is relatively thin.

FIG. 8 is a diagram illustrating an example of the transmission band of the bandpass filter in a case where the film thickness of the cavity layer is relatively thick.

FIG. 9 is a diagram illustrating results of a preliminary experiment for improving cloudiness.

FIG. 10 is a diagram illustrating transition of a temperature and a monitor light quantity in a film formation step in the preliminary experiment illustrated in FIG. 9.

FIG. 11 is a schematic cross-sectional view illustrating an example of a film forming apparatus that performs the film formation step in a method for producing the bandpass filter according to the present embodiment.

FIG. 12 is a diagram illustrating an example of monitoring a film formation state by a direct-view monitor.

FIG. 13 is a view illustrating the transition of the temperature and the monitor light quantity in the film formation step in the method for producing the bandpass filter according to the present embodiment.

FIG. 14 is a diagram illustrating transmission bands of bandpass filters according to Example and Comparative Example.

FIG. 15 is an appearance comparison photograph of the bandpass filters according to Example and Comparative Example.

### DESCRIPTION OF EMBODIMENTS

Hereinafter, a preferred embodiment of a method for producing a bandpass filter and a bandpass filter according to one aspect of the present disclosure will be described in detail with reference to the drawings.

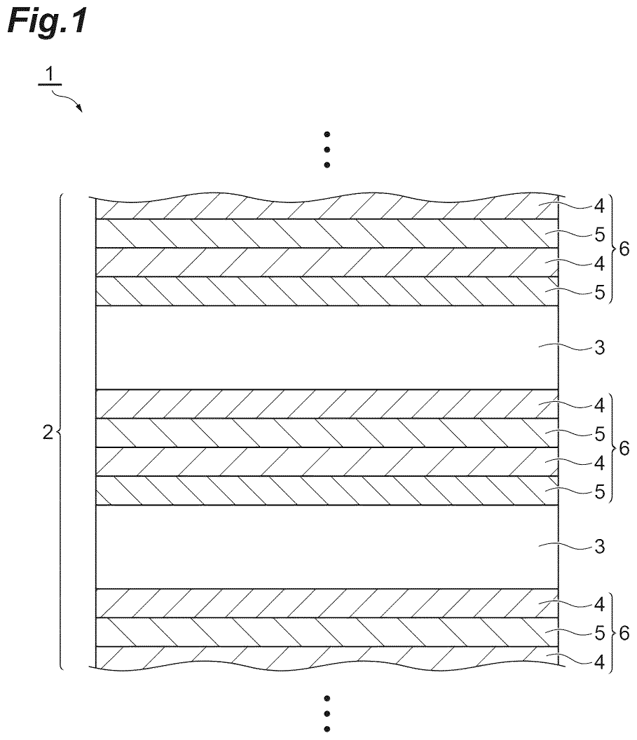

FIG. 1 is a schematic cross-sectional view illustrating a layer configuration of the bandpass filter according to an embodiment of the present disclosure. As illustrated in the figure, a bandpass filter 1 is made of a dielectric multilayer film 2 including a plurality of cavity layers 3 and a plurality of laminated portions 6 including a first dielectric layer 4 and a second dielectric layer 5. The cavity layer 3 is a layer having a larger film thickness than the first dielectric layer 4 and the second dielectric layer 5. General examples of constituent materials of the cavity layer include Si—H (refractive index n=3.3), TiO₂ (refractive index n=2.3), and SiO₂ (refractive index n=1.45). In the present embodiment, the cavity layer 3 is formed of TiO₂ having a highest refractive index among film-forming materials of a metal oxide.

The laminated portion 6 is provided to sandwich the cavity layer 3 in a laminating direction. In the laminated portion 6, the first dielectric layers 4 and the second dielectric layers 5 are alternately laminated. The number of laminated layers of the first dielectric layers 4 and the number of laminated layers of the second dielectric layers 5 in the laminated portion 6 are, for example, the same with each other. In an example of FIG. 1, the laminated portion 6 includes two first dielectric layers 4 and two second dielectric layers 5.

The first dielectric layer 4 is a high refractive index dielectric layer formed of a high refractive index material having a refractive index higher than that of the second dielectric layer 5. The second dielectric layer 5 is a low refractive index dielectric layer formed of a low refractive index material having a refractive index lower than that of the first dielectric layer 4. Examples of the high refractive index material used for forming the first dielectric layer 4 include Si (refractive index n=3.4), Si—H (refractive index n=3.3), TiO₂ (refractive index n=2.3), and Ta₂O₅ (refractive index n=2.05). Examples of the low refractive index material used for forming the second dielectric layer 5 include SiO₂ (refractive index n=1.45).

In the bandpass filter 1 having the above configuration, the laminated portion 6 formed by alternately laminating the first dielectric layer 4 and the second dielectric layer 5 functions as a reflection structure for incident light. In addition, the cavity layer 3 functions as a spacer sandwiched by the reflection structure. The light incident on the bandpass filter 1 becomes multiple beams while repeating multiple reflection in the cavity layer 3, and is transmitted at a wavelength in a band where phases of the beams strengthen each other.

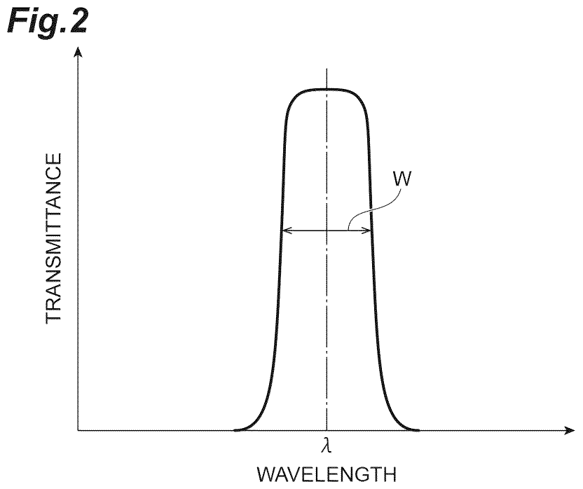

Therefore, as illustrated in FIG. 2, the bandpass filter 1 has a narrow transmission band W having a center wavelength of A. In general, the transmission band of the bandpass filter by the dielectric multilayer film having the cavity layer has a Lorentzian spectral shape. In the present embodiment, since the dielectric multilayer film 2 has the plurality of cavity layers 3, the spectral shape approaches a rectangular shape, and a transmittance in the transmission band W is flattened.

In the bandpass filter 1, when the center wavelength of the transmission band W is λ and the film thickness of the cavity layer 3 is D, D=λ/2×m (m is an integer of 3 or more). The center wavelength λ is, for example, 400 nm or more and 1000 nm or less. The center wavelength 2 may be 400 nm or more and 800 nm or less. In the bandpass filter 1, the transmittance in the transmission band W is 80% or more. Further, in the bandpass filter 1, cloudiness of the cavity layer 3 to be described later is suppressed, and scattering in the transmission band W is less than 5%.

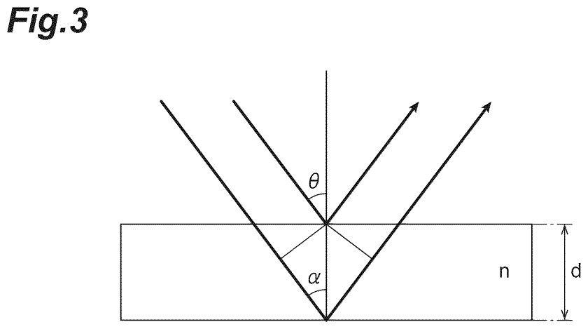

In general, the bandpass filter has angle dependence with respect to an incident angle θ of light. The angle dependence is caused based on an optical path difference between reflected light on one surface of the cavity layer and reflected light on the other surface of the cavity layer. As illustrated in FIG. 3, the optical path difference is derived by Snell's law and a trigonometric function formula. When the thickness of the cavity layer is d, an incident angle of light with respect to one surface of the cavity layer is θ, an incident angle of light with respect to the other surface of the cavity layer is α, a refractive index of the cavity layer is n, and a refractive index of an outside (air) is 1, an optical path difference Δ between the reflected light on the one surface and the reflected light on the other surface is expressed by Δ=2nd×cos α. By applying Snell's law (n×sin α=sin θ) and the trigonometric function formula to this formula, the optical path difference Δ can be obtained by the following formula (1).

$$\begin{matrix}[ Formula 1 ] & \\ Δ = 2 nd \sqrt{1 - {( \frac{sin θ}{n} )}^{2}} & ( 1 )\end{matrix}$$

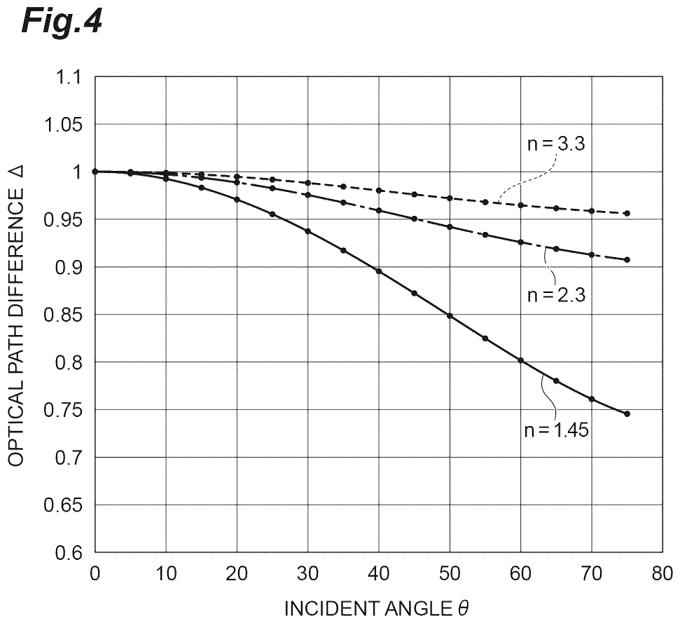

As illustrated in FIG. 4, it can be seen that the optical path difference Δ is maximized at θ=0° and gradually decreases as θ increases. In addition, as illustrated in FIG. 4, it can be seen that a decrease amount of the optical path difference Δ is smaller when the refractive index is large than when the refractive index is small. In the bandpass filter, the center wavelength of the transmission band shifts to a shorter wavelength side as the optical path difference decreases. Therefore, from the viewpoint of reducing the angle dependence of the bandpass filter, it is advantageous to use a high refractive index material such as TiO₂ for the cavity layer.

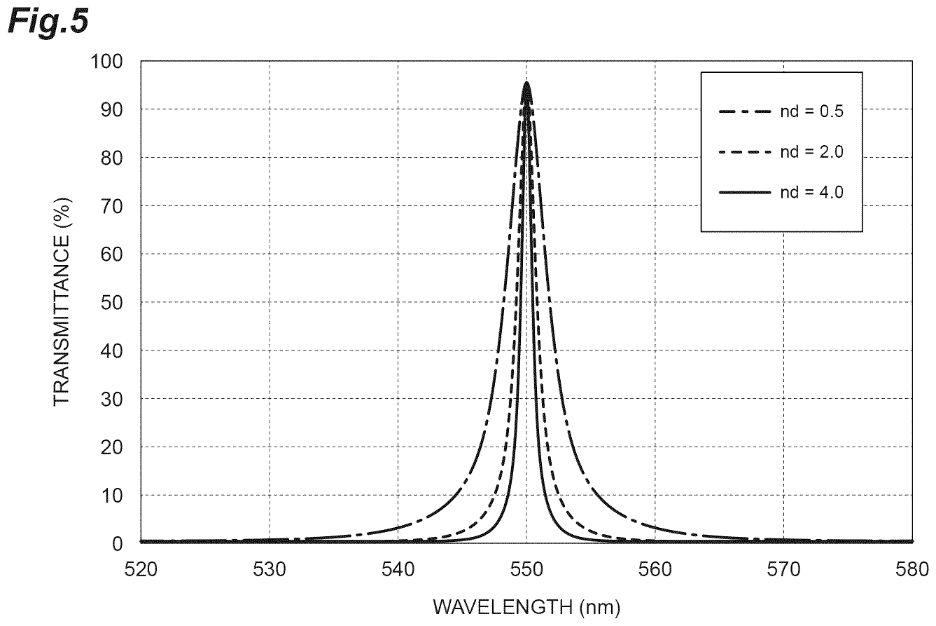

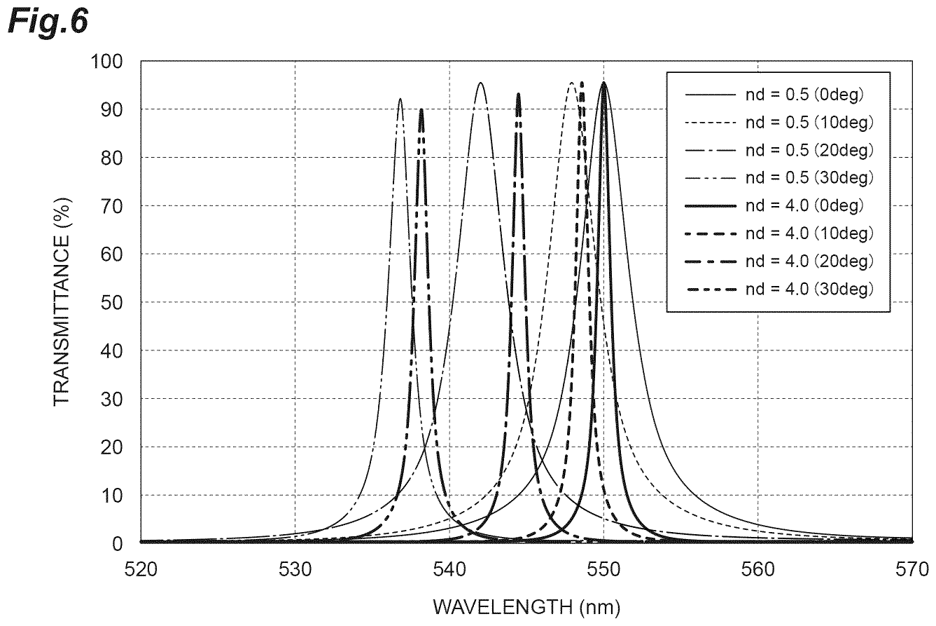

The film thickness of the cavity layer is also an important factor in film design of the bandpass filter. For example, as illustrated in FIG. 5, as the film thickness of the cavity layer is larger, the transmission band is narrower and has a sharper rise. In addition, as illustrated in FIG. 6, when the high refractive index material such as TiO₂ is used for the cavity layer, the angle dependence decreases as the film thickness increases. From the above, it is considered that it is necessary to form a cavity layer having a large film thickness using the high refractive index material such as TiO₂ in order to reduce the angle dependence of the bandpass filter.

On the other hand, when the cavity layer having the large film thickness is formed using the high refractive index material such as TiO₂, there is a problem that crystallization of TiO₂ proceeds and the cavity layer becomes cloudy during film formation. When cloudiness occurs in the cavity layer, the transmission band of the bandpass filter may be greatly deviated from the design. Further, the cloudiness of the cavity layer can also be a factor in scattering of light incident on the bandpass filter.

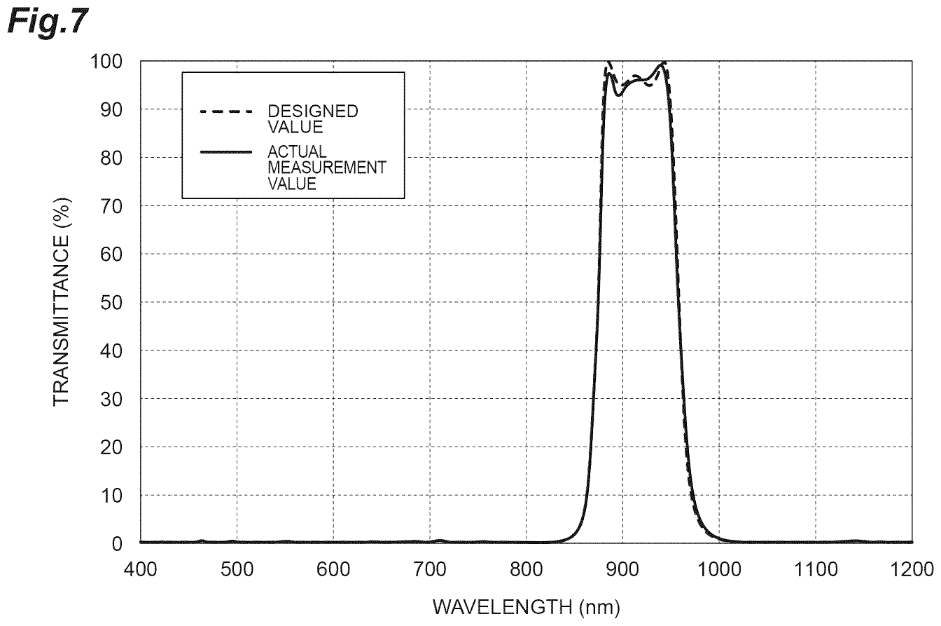

FIG. 7 is a diagram illustrating an example of the transmission band of the bandpass filter in a case where the film thickness of the cavity layer is relatively thin. In the bandpass filter in the figure, TiO₂ was used for the cavity layer, and the film thickness D of the cavity layer was set to D=λ/2×m (m is an integer of 2 or less). The number of cavity layers formed was 4, and the total number of dielectric multilayer films laminated was 25. As illustrated in FIG. 7, in a case where the film thickness of the cavity layer is relatively thin, it can be seen that the cloudiness is not observed in the cavity layer even when the cavity layer is formed using the high refractive index material such as TiO₂, and a bandpass filter having a transmission band substantially as designed can be produced.

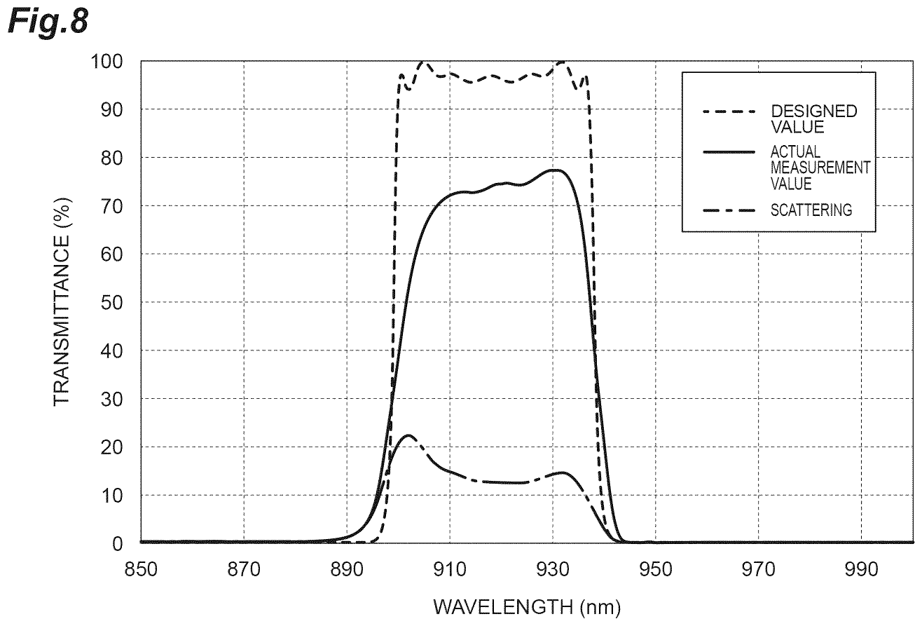

On the other hand, FIG. 8 is a diagram illustrating an example of the transmission band of the bandpass filter in a case where the film thickness of the cavity layer is relatively thick. In the bandpass filter in the figure, TiO₂ was used for the cavity layer, and the film thickness D of the cavity layer was set to D=λ/2×m (m is 3). The number of cavity layers formed was 7, and the total number of dielectric multilayer films laminated was 58. As illustrated in FIG. 8, in a case where the film thickness of the cavity layer was relatively large, when the cavity layer was formed using the high refractive index material such as TiO₂, the cloudiness was observed in the cavity layer. As a result, it was confirmed that the transmittance in the transmission band decreased by about 20% to 30% from a designed value, and the scattering occurred by 10% to 20%.

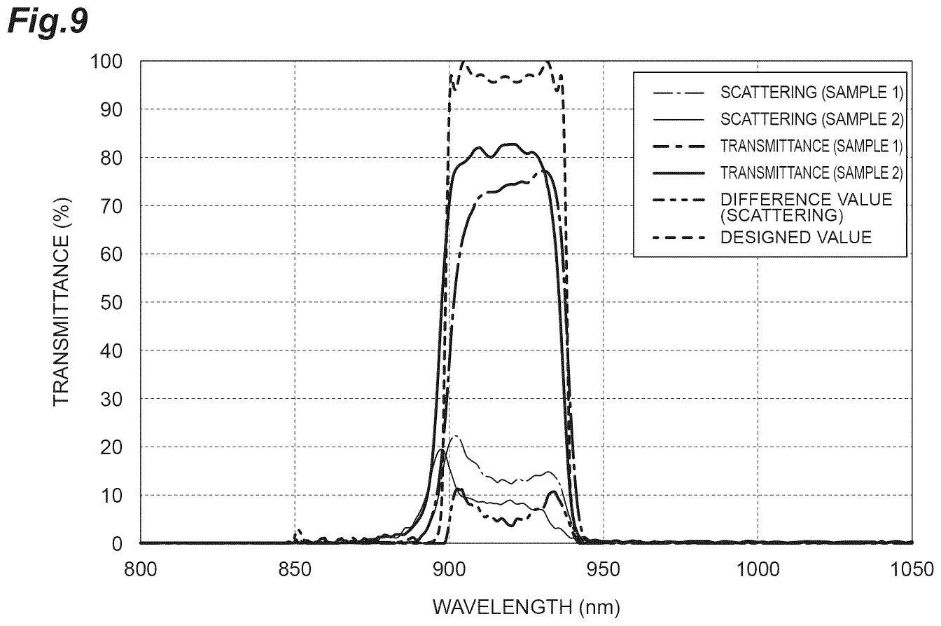

For such a problem of cloudiness, the applicant conducted a preliminary experiment for improving cloudiness as illustrated in FIG. 9. In the bandpass filter of the figure, for two samples of a bandpass filter having a cavity layer made of TiO₂ and having a relatively thick film as in FIG. 8, one of the two samples was formed under normal film forming conditions (Sample 1), and the other was formed at a lower film formation temperature than that under the normal film forming conditions (Sample 2). Here, the number of cavity layers formed was 4, and the total number of dielectric multilayer films laminated was 25. In Sample 2, a temperature at the start of film formation was 60° C. or lower. As a result, as illustrated in FIG. 9, in Sample 2, the cloudiness was improved as compared with Sample 1, and the scattering was also improved by about 5% to 10%.

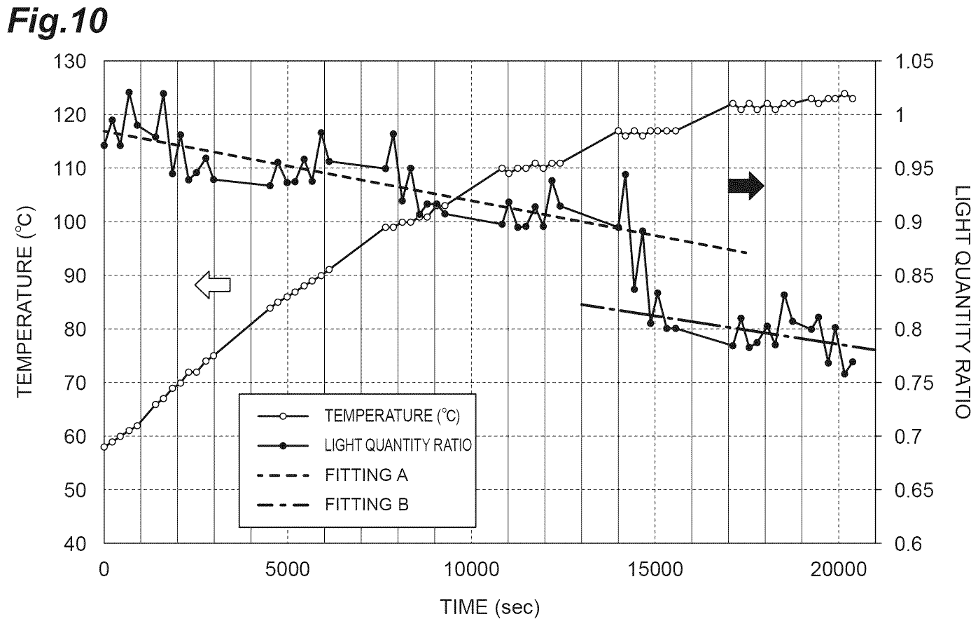

Next, the applicant focused on a monitor light quantity in the film formation step. FIG. 10 is a diagram illustrating transition of the temperature and the monitor light quantity in the film formation step in the preliminary experiment. In the figure, a horizontal axis represents time, a vertical axis (left) represents temperature, and a vertical axis (right) represents light quantity ratio. A portion where a time interval of a plot is sparse corresponds to a film formation period of the high refractive index dielectric layer and the low refractive index dielectric layer, and a portion where the time interval of the plot is sparse corresponds to a film formation period of the cavity layer. The light quantity ratio is a value obtained by dividing a calculated value by an actual measurement value, and indicates that the transmittance decreases as the value decreases.

From the result of FIG. 10, the light quantity ratio decreases substantially linearly in accordance with the number of laminated layers. In addition, it is presumed that the light quantity ratio sharply decreases around a temperature exceeding 110° C., and the crystallization of TiO₂ constituting the cavity layer significantly proceeds around the temperature. Change in the light quantity ratio during a period in which the cavity layer is formed is also remarkable, and it is presumed that temperature rise of a film formation substrate due to radiation heating during a TiO₂ film formation period has a large influence. From the above, the applicant has obtained knowledge that if the crystallization of TiO₂ can be suppressed by suppressing the temperature rise at the time of the film formation, the cloudiness of the cavity layer can be suppressed even when the cavity layer having a large film thickness is formed using the high refractive index material, and has completed the method for producing the bandpass filter according to the present disclosure.

Hereinafter, the method for producing the bandpass filter according to the present embodiment will be described.

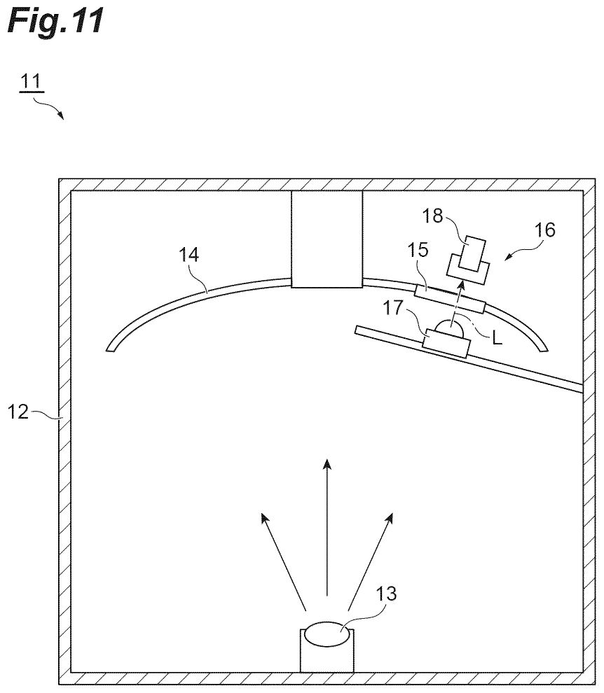

FIG. 11 is a schematic cross-sectional view illustrating an example of a film forming apparatus that performs the film formation step in the method for producing the bandpass filter according to the present embodiment. A film forming apparatus 11 illustrated in the figure is a vacuum vapor deposition apparatus and includes a vacuum chamber 12. In the vacuum chamber 12, a vapor deposition source 13, a rotary dome 14, a film formation substrate 15, and a temperature sensor (not illustrated) are arranged. In the film forming apparatus 11, the vapor deposition source 13 of metal, metal oxide, or the like is evaporated or sublimated in the vacuum chamber 12, and particles of the film-forming material are attached to a surface of the film formation substrate 15 attached to the rotary dome 14 to form each layer of the dielectric multilayer film 2.

In the film forming apparatus 11, a monitor 16 for monitoring a film formation state of each layer of the dielectric multilayer film 2 is disposed. In the present embodiment, the monitor 16 is not an indirect monitor that monitors a transmittance of a sample substrate at a center of the rotary dome 14, but a direct-view monitor that monitors the transmittance of the film formation substrate 15 itself. The monitor 16 includes a light source 17 and an optical sensor 18. The light source 17 emits measurement light L toward the film formation substrate 15. The optical sensor 18 detects an intensity of the measurement light L transmitted through the film formation substrate 15. A detection signal from the optical sensor 18 is output to a control unit (not illustrated) or the like. The control unit controls the film forming apparatus 11 based on the detection signal so that an optical film thickness of each layer during the film formation becomes a designed value.

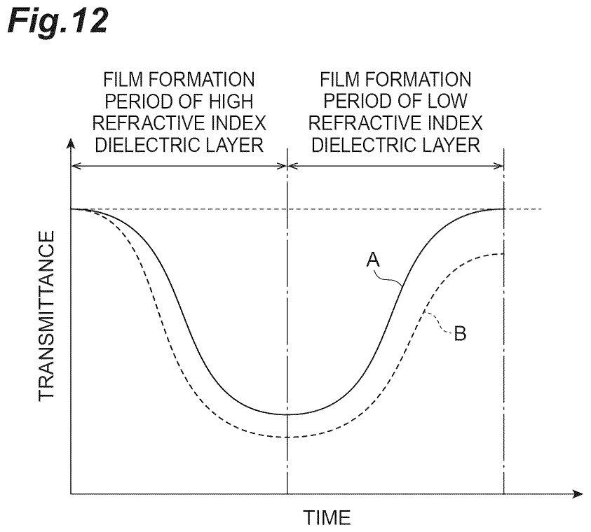

FIG. 12 is a diagram illustrating an example of monitoring the film formation state by the direct-view monitor. The figure schematically illustrates a change in transmittance of the film formation substrate when the high refractive index dielectric layer and the low refractive index dielectric layer are formed one by one. As illustrated in FIG. 12, as a basic behavior, the transmittance of the film formation substrate gradually decreases during the film formation period of the high refractive index dielectric layer. On the other hand, the transmittance of the film formation substrate gradually increases during the film formation period of the low refractive index dielectric layer. In a case where there is no optical loss (absorption, scattering, and the like) in the formed dielectric layer, a transmittance (start light quantity) at the start of the film formation and a transmittance (stop light quantity) at the end of the film formation coincide with each other (FIG. 12: graph A). In a case where there is an optical loss (absorption, scattering, or the like) in the formed dielectric layer, the transmittance (stop light quantity) at the end of the film formation decreases in accordance with the degree of the optical loss with respect to the transmittance (start light quantity) at the start of the film formation (FIG. 12: graph B).

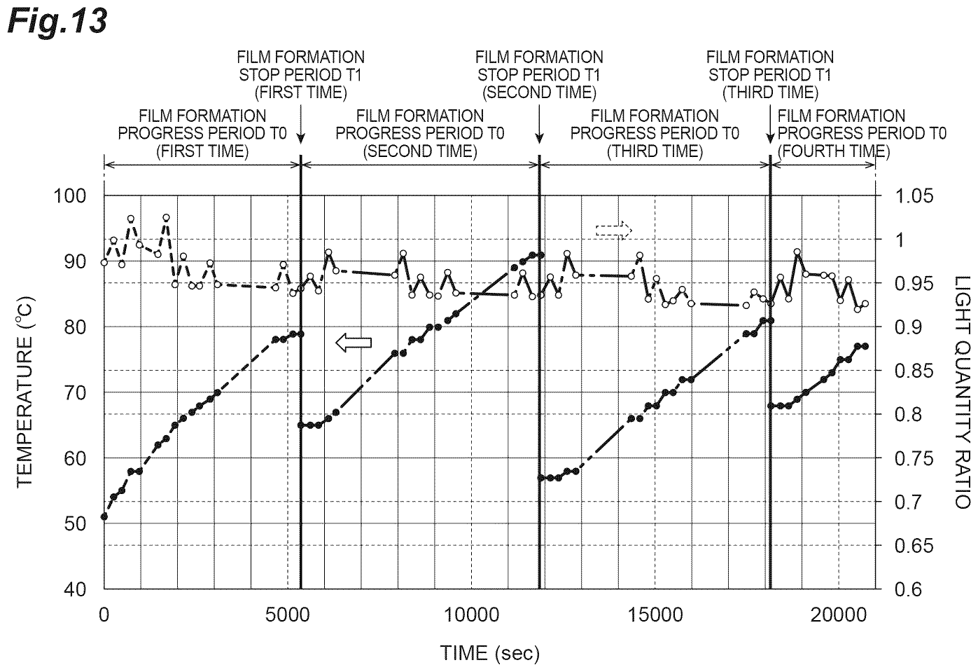

FIG. 13 is a view illustrating the transition of the temperature and the monitor light quantity in the film formation step in the method for producing the bandpass filter according to the present embodiment. As illustrated in the figure, in the method for producing the bandpass filter, in the film formation step of the dielectric multilayer film 2, a film formation progress period T0 in which the film formation proceeds and a film formation stop period T1 in which a temperature of the film formation substrate 15 is lowered by temporarily stopping the film formation are set.

In the film formation progress period T0, the temperature of the film formation substrate 15 increases, and in each film formation stop period T1, the temperature of the film formation substrate 15 decreases. In the next film formation progress period T0, the film formation is resumed in a state where the temperature is lowered. In the film formation stop period T1, for example, the film formation substrate 15 may be cooled by heat dissipation from the entire film forming apparatus 11 while continuing to evacuate the vacuum chamber 12 as in the film formation progress period T0. In the film formation stop period T1, the film formation substrate 15 may be cooled by releasing the vacuum state in the vacuum chamber 12 and introducing a cooling medium such as air into the vacuum chamber 12.

Usually, a temperature at which the Ti oxide (Ti₃O₅) that is a vapor deposition source is sufficiently oxidized and TiO₂ is stably formed is around 120° C. In the present embodiment, the film formation stop period T1 is set such that the temperature of the film formation substrate 15 is lower than 120° C. over an entire period of the film formation step. In an example of FIG. 13, a plurality of (here, three) film formation stop periods T1 are set during the entire period of the film formation step, and the film formation progress period T0 is temporally divided into four by these film formation stop periods T1.

In a first film formation progress period T0, after a film up to a second layer cavity layer 3 was formed, a film up to a second layer second dielectric layer 5 of a next laminated portion 6 was formed. In the first film formation progress period T0, the temperature of the film formation substrate 15 increased from about 50° C. to about 80° C. A first film formation stop period T1 was started in a state where an outermost layer was the second dielectric layer 5. The first film formation stop period T1 was set to about 2 hours. In the first film formation stop period T1, the temperature of the film formation substrate 15 decreased from about 80° C. to about 65° C.

In a second film formation progress period T0, after a film up to a fourth layer cavity layer 3 was formed following the first film formation progress period T0, a film up to a second layer second dielectric layer 5 of a next laminated portion 6 was formed. In the second film formation progress period T0, the temperature of the film formation substrate 15 increased from about 65° C. to about 90° C. A second film formation stop period T1 was started in a state where the outermost layer was the second dielectric layer 5. The second film formation stop period T1 was set to about 4 hours. In the second film formation stop period T1, the temperature of the film formation substrate 15 decreased from about 90° C. to about 55° C.

In a third film formation progress period T0, after a film up to a sixth layer cavity layer 3 was formed following the second film formation progress period T0, a film up to a second layer second dielectric layer 5 of a next laminated portion 6 was formed. In the third film formation progress period T0, the temperature of the film formation substrate 15 increased from about 55° C. to about 80° C. A third film formation stop period T1 was started in a state where the outermost layer was the second dielectric layer 5. The third film formation stop period T1 was set to about 2 hours. In the first film formation stop period T1, the temperature of the film formation substrate 15 decreased from about 80° C. to about 65° C.

In a fourth film formation progress period T0, a film up to a last layer was formed including a seventh layer cavity layer 3 following the third film formation progress period T0. In the fourth film formation progress period T0, the temperature of the film formation substrate 15 increased from about 55° C. to about 80° C.

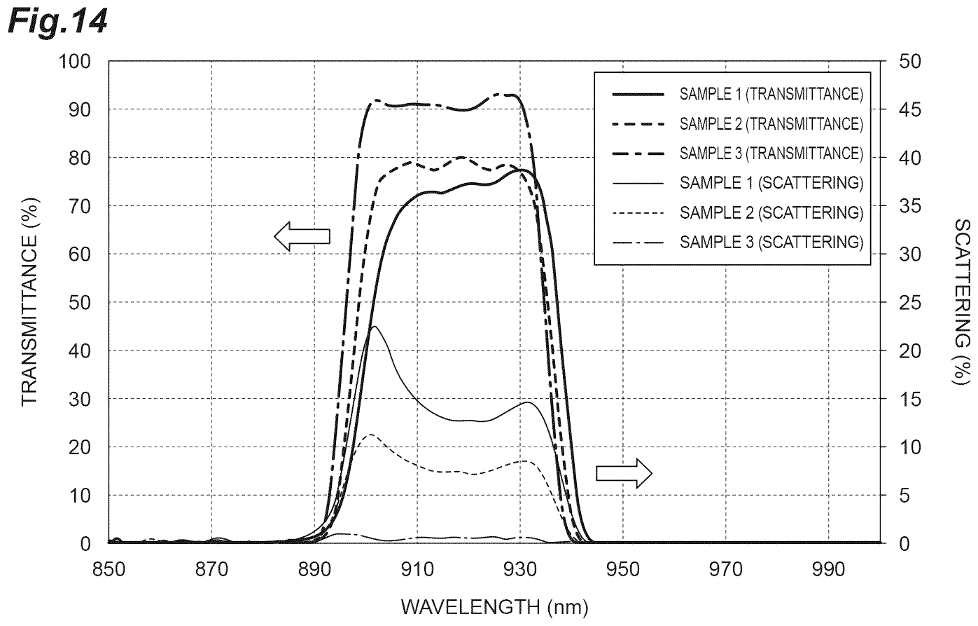

FIG. 14 is a diagram illustrating transmission bands of bandpass filters according to Example and Comparative Example. In the figure, the transmittance and the scattering are measured for samples of three bandpass filters formed under different film forming conditions. Sample 1 and Sample 2 are Comparative Examples, and continuous film formation was performed without setting the film formation stop period T1 in the film formation step. In Sample 1, the temperature at the time of film formation was constant at 120° C. In Sample 2, a minimum temperature at the time of film formation was 60° C., and a maximum temperature was 123° C. Sample 3 is Example, and similarly to the example of FIG. 13, three film formation stop periods T1 were set, and the film formation progress period T0 was temporally divided into four by these film formation stop periods T1. In Sample 3, the minimum temperature at the time of film formation was 55° C., and the maximum temperature was 93° C.

As illustrated in FIG. 14, in Sample 1, the transmittance in the transmission band is about 75%, and the scattering of about 30% to 40% occurs. In Sample 2, the transmittance in the transmission band is about 80%, and the scattering of about 15% to 20% occurs. In contrast, in Sample 3, the transmittance in the transmission band is improved to about 90%, and the scattering is also suppressed to less than 5%.

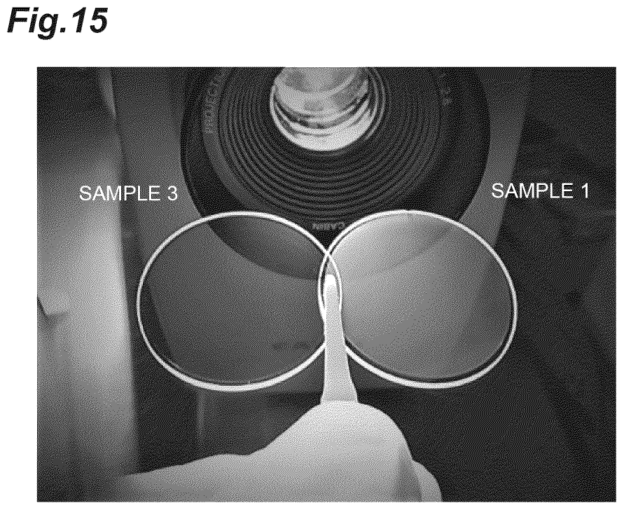

FIG. 15 is an appearance comparison photograph of the bandpass filters according to Example and Comparative Example. A right side in FIG. 15 is an appearance of Sample 1, and a left side in FIG. 15 is an appearance of Sample 3. An illumination apparatus for photographing Samples 1 and 3 is placed on a back side of Samples 1 and 3. As illustrated in the figure, in Sample 3 produced by setting the film formation stop period T1 in the film formation step, improvement in the cloudiness was observed to an obvious extent even with naked eyes as compared with Sample 1 produced without setting the film formation stop period T1 in the film formation step.

As described above, in the method for producing the bandpass filter according to the present embodiment, the temperature of the film formation substrate 15 is lowered by setting the film formation stop period T1 in the film formation step of the dielectric multilayer film 2. Thus, progress of the crystallization of TiO₂ can be suppressed as compared with a case where all layers are continuously formed. Therefore, even when the cavity layer 3 having the large film thickness is formed using TiO₂ that is the high refractive index material, it is possible to suppress the cloudiness of the cavity layer 3. By suppressing the cloudiness of the cavity layer 3, in the produced bandpass filter 1, the transmittance in the transmission band W can be improved and the scattering can be sufficiently reduced, and the angle dependence on incident light can be reduced.

In the present embodiment, the film formation stop period T1 is set to a period in which an outermost layer of the dielectric multilayer film 2 is the second dielectric layer 5. Stability of the film formation can be improved by performing the film formation stop period T1 in a state in which the low refractive index dielectric layer made of a material having relatively high stability with respect to an external environment is used as the outermost layer of the dielectric multilayer film 2.

In the present embodiment, the film formation stop period T1 is set a plurality of times in the film formation step. Thus, it is possible to stably suppress an increase in the temperature of the film formation substrate 15 over the entire period of the film formation step. Therefore, the cloudiness of the cavity layer 3 can be more reliably suppressed.

In the present embodiment, when the center wavelength of the transmission band W is λ and the film thickness of the cavity layer 3 formed in the film formation step is D, D=λ/2×m (m is an integer of 3 or more). According to the present method, even when the cavity layer 3 having the large film thickness is formed such that D=λ/2×m (m is an integer of 3 or more), the cloudiness of the cavity layer 3 can be suitably suppressed.

In the present embodiment, λ is 400 nm or more and 1000 nm or less. According to the present method, even when the cavity layer 3 having the large film thickness is formed such that the λ is 400 nm or more and 1000 nm or less, the cloudiness of the cavity layer 3 can be suitably suppressed.

In the present embodiment, the film formation step is performed using the film forming apparatus 11 which is the vacuum vapor deposition apparatus. According to the film forming apparatus 11, by stopping the film formation in a state of maintaining a vacuum state in the apparatus in the film formation stop period T1, the temperature of the film formation substrate 15 can be relatively easily lowered by heat dissipation of the entire apparatus.

The present disclosure is not limited to the above embodiment. For example, in the above embodiment, the three film formation stop periods T1 are set during the entire period of the film formation step, and the film formation progress period T0 is temporally divided into four by these film formation stop periods T1, however, the number of times of setting the film formation stop period T1 may be arbitrarily set according to specifications and the like of the film forming apparatus 11. The outermost layer when the film formation stop period T1 is performed is not necessarily the second dielectric layer 5. That is, the outermost layer when the film formation stop period T1 is performed may be the first dielectric layer 4 or the cavity layer 3.

### REFERENCE SIGNS LIST

1 bandpass filter
2 dielectric multilayer film
3 cavity layer
4 first dielectric layer
5 second dielectric layer
6 laminated portion
11 film forming apparatus (vacuum vapor deposition apparatus)
15 film formation substrate
T1 film formation stop period
W transmission band.

1: A method for producing a bandpass filter made of a dielectric multilayer film comprising:
a cavity layer made of TiO₂; and
laminated portions arranged to sandwich the cavity layer, the laminated portion being formed by alternately laminating a first dielectric layer made of a high refractive index material and a second dielectric layer made of a low refractive index material, wherein
in a film formation of the dielectric multilayer film, a film formation stop period to lower a temperature of a film formation substrate by temporarily stopping film formation during the film formation is set.

2: The method for producing the bandpass filter according to claim 1, wherein the film formation stop period is set to a period in which an outermost layer of the dielectric multilayer film is the second dielectric layer.

3: The method for producing the bandpass filter according to claim 1, wherein the film formation stop period is set a plurality of times in the film formation.

4: The method for producing the bandpass filter according to claim 1, wherein when a center wavelength of a transmission band is λ and a film thickness of the cavity layer formed in the film formation is D, D=λ/2×m (m is an integer of 3 or more).

5: The method for producing the bandpass filter according to claim 4, wherein the λ is 400 nm or more and 1000 nm or less.

6: The method for producing the bandpass filter according to claim 1, wherein the film formation is performed using a vacuum vapor deposition apparatus.

7: A bandpass filter made of a dielectric multilayer film comprising:
a cavity layer made of TiO₂; and
a laminated portion formed by alternately laminating a first dielectric layer made of a high refractive index material and a second dielectric layer made of a low refractive index material, wherein
when a center wavelength of a transmission band is λ and a film thickness of the cavity layer is D, D=λ/2×m (m is an integer of 3 or more), and
a transmittance in the transmission band is 80% or more.

8: The bandpass filter according to claim 7, wherein scattering in the transmission band is less than 5%.
